(19) United States
(12) Patent Application Publication
(10) Pub. No.: US 2010/0082650 A1
(43) Pub. Date: Apr. 1, 2010

(54) Method, System, and Apparatus for Ranking Media Sharing Channels

(76) Inventor: Davin Wong, Helsinki (FI)

Correspondence Address: Hollingsworth & Funk, 8500 Normandale Lake Blvd., Suite 320, Minneapolis, MN, 55437, US

(21) Appl. No.: 12/237,028

(22) Filed: Sep. 24, 2008

(51) Int. Cl. G06F 17/30

(52) U.S. Cl. 707/758; 707/E17.001

(57) ABSTRACT

Ranking media sharing channels involves determining content contributors to a channel. Activity metrics for other channels associated with the content contributors are determined. An initial ranking for the channel is provided based on the activity metrics for the other channels. The initial ranking is independent of activity metrics associated with the channel.

### FIELD OF THE INVENTION

This invention relates in general to network data, and more particularly to systems, apparatuses and methods for ranking media sharing channels.

### BACKGROUND

This discussion below relates to discovering of online shared user content. Online media sharing sites (e.g., Share on Ovi™, formerly known as Twango) may include features that allow a contributor to organize and share his or her media. In the Ovi Share system, this feature is referred to as “channels.” Ovi Share channels are containers that help one organize and share his/her media. Anyone can create channels for types of media, specific topics, or any other classification system desired. For example, one can create a channel that contains photos of one's family, sports or countries, or a channel for a specific trip or event.

Contribution to the content of a channel needs not be limited to a single source. The owner of a channel can grant any number of people contribution rights to the channel at any time. For example, a channel can be set up for an event such as a concert by the organizer so that any concert goers can contribute their photos or videos from the event to the channel. Similarly, viewership of a channel can be controlled by the owner. At any time, the owner can modify view access to any number of people. For example, a cat channel can be set up with public view access so any member of the public can view a member's collection of cat photos.

Public channels (channels with public view access) may be prevalent on such media sharing systems. For example, all new members may be assigned a default public channel upon account creation. As the membership of these services grows and the number of public channels soars, it may become impractical for users to browse through the entire collection of public channels available on the site. To facilitate this type of browsing, the media sharing service ranks public channels according to various activity measures.

Activity measures that used in ranking public channels may include the number of views or comments received by the channel, etc. The ranked channels are further paginated within a selected results page. By selecting any of the criteria and browsing through the first few result pages, a user can quickly identify which channels are most frequently engaged by the community and may therefore interest him/her.

### SUMMARY

In some example embodiments, the present invention discloses a system, apparatus and method for ranking new network content. In one aspect, a method involves determining content contributors to a channel. Activity metrics for other channels associated with the content contributors are determined. An initial ranking for the channel is provided based on the activity metrics for the other channels. The initial ranking is independent of activity metrics associated with the channel.

In another aspect, an apparatus includes one or more processors configured to determine content contributors to a channel and determine activity metrics for other channels associated with the content contributors. The processors further provide an initial ranking for the channel is provided based on the activity metrics for the other channels. The initial ranking is independent of activity metrics associated with the channel.

In another aspect, a computer-readable storage medium includes instructions which are executable by an apparatus for performing operations that include: a) determining content contributors to a channel; b) determining activity metrics for other channels associated with the content contributors; and c) providing an initial ranking for the channel based on the activity metrics for the other channels. The initial ranking is independent of activity metrics associated with the channel.

In another aspect, an apparatus includes; a) means for determining content contributors to a channel; b) means for determining activity metrics for other channels associated with the content contributors; and c) means for providing an initial ranking for the channel based on the activity metrics for the other channels. The initial ranking is independent of activity metrics associated with the channel.

In variations of the above, the method, apparatus, and computer-readable medium may attenuate the initial ranking based on an age of the new channel, and/or may further be supervised by a single one of the contributors to the new channel. In addition, the channel may include a collection of network-accessible media objects of a media sharing service and/or the initial ranking may be provided for purposes of ordering the channel, based at least in part on the initial ranking, in a rank-ordered view of channels of a media sharing service. Further in these variations, the ordering of the new channel in the rank-ordered view may occur in response to one or both of a search query and presenting a predetermined view of the media sharing service. In such a case, the method, apparatus, and computer-readable medium may apply weightings to each of the activity metrics, and the weightings can be selected based on one or both of parameters of the search query and parameters defined for the predetermined view of the media sharing service.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with example embodiments illustrated in the following diagrams.

FIG. 1 is a block diagram illustrating formation and ranking of channels according to an example embodiment of the invention;

FIGS. 2A and 2B are a block diagrams illustrating data inputs gathered to rank new channels according to an example embodiment of the invention;

FIG. 3 is a flowchart illustrating ranking of new media sharing channels according to an example embodiment of the invention;

FIG. 4 is a flowchart illustrating ranking of new media sharing channels according to an example embodiment of the invention;

FIG. 5 is a block diagram illustrating a system that utilizes a ranking component for new media channels according to an example embodiment of the invention; and

FIG. 6 is a block diagram of a service apparatus according to an example embodiment of the invention.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

Generally, the present disclosure is related to helping users discover highly relevant and interesting content that is publicly accessible via online content sharing sites. The sites may generally group individual content items (e.g., digital photos, videos, audio, etc.) under predefined public “channels.” These channels may be ranked based on metrics of use (e.g., number of views, number of comments, number of times linked to, etc.). Channel usage metrics are an indicator of current popularity, although reliance on these usage metrics may prevent newly created channels from being immediately recognized. Even though a new channel may contain highly interesting (and eventually popular) content, if it has not had time to accumulate enough community attention, its ranking will be low and may not appear in the top results for some time.

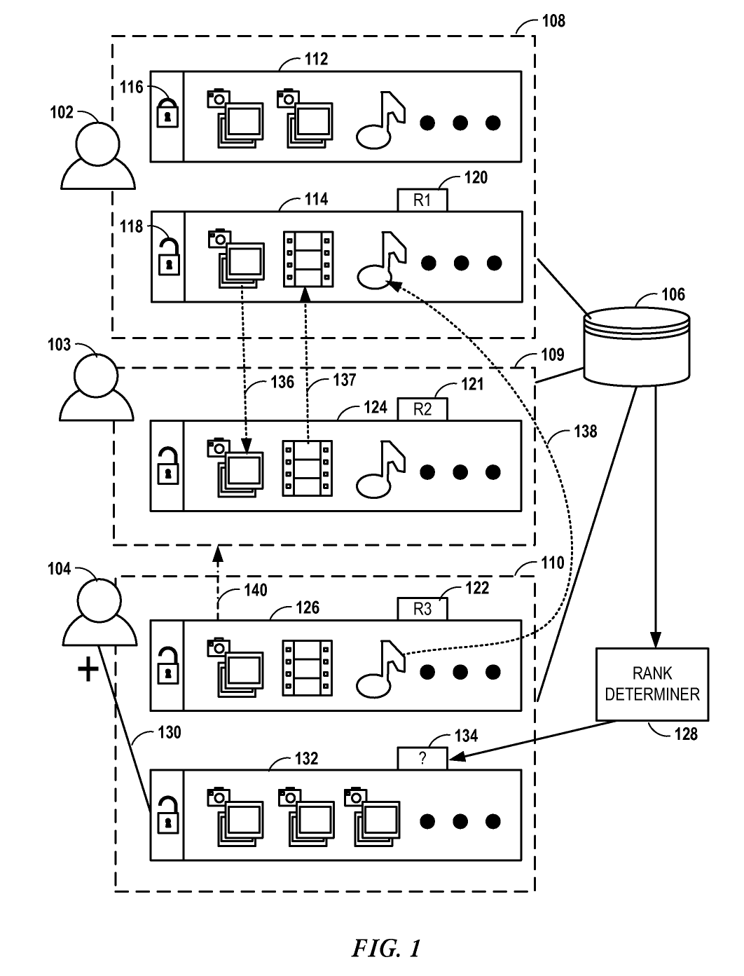

An example embodiment of a system in which concepts of the invention may be employed is shown in the block diagram of FIG. 1. Users 102-104 are members of an online media sharing service, represented by repository 106. Each user 102-104 may maintain at least one account with the service, as represented by accounts 108-110, respectively. Each of the accounts 108-110 may include one or more channels of shared media.

Using account 108 as an example, user 102 has established two channels, 112, 114. These channels 112, 114 are examples of media content (e.g., photos, videos, audio, graphics, text, etc.) that is grouped based on criteria typically defined by the associated user 102. Channel 112 is private, as indicated by icon 116. This privacy status 116 generally involves limiting access to at least some users, and the user 102 may control access to the channel 112 using techniques known in the art (e.g., access/denial lists, authentication, etc.) Channel 114 is public as indicated by icon 118. The public status 118 indicates that anybody may at least view/render content of the channel 114, although other activities may still be restricted (e.g., ability to comment on, contribute content to, remove content from, or perform other actions on channel and its content).

The public status 118 of channel 114 is of interest in the following discussion because the channel content may be searched via the repository 106. Although private channels (e.g., channel 112) may also be searched by those with viewing permissions, the ability of the general public, including non-members, to search public channels is an attractive feature for a number of reasons. There may be a very large number of public channels accessible via an individual in comparison to the number of private channels accessible by that individual. Also, the use of searching or predefined views of content (e.g., most commented) allows content creators to gain exposure, and provides others to find content of interest. As with most search strategies, a way of ranking results is needed in order to better match results to searches/views.

The system may include a number of ways for ranking a particular channel. This is indicated by ranking values 120-122 associated with public channels 114, 124, and 126, respectively. The channels (and their underlying content in some cases) may be ranked according to activity indicators such as numbers of most visited, most shared, etc. Such activity indicators are useful, although sometimes can tend to lead to “feedback loops,” e.g., where highly ranked content has a tendency to stay highly ranked and prevent new content from moving up the list. This can occur, for example, where new visitors only visit the channels that are highly ranked. Thus, where measures such as “most visited” are used in the ranking, the existing high ranking of some channels will increase the number of visits to those channels even more. In such situations, it can be difficult for newly added content to become visible, no matter how compelling the content may be. To discover these potential “hidden gems.” an alternative method for channel ranking is described hereinbelow.

Generally, the example embodiments describe an improved ranking method for showcasing recently created channels that may interest the community of the service 106 at large. Such an improved ranking may provide technical effects such as increased efficiency in displaying results due to fewer queries needing to be submitted by visitors ranking system, and by making it easier for people to find interesting pictures and thereby reducing data traffic and time to find interesting pictures. Other technical effects may include providing data to system administrators on how to better allocate resources, e.g., by assigning more processing resources to those channels/accounts more likely to prove popular to end users. This allocation of resources may in turn improve aggregate system performance.

In FIG. 1, this improved ranking capability is indicated by rank determining component 128. In the illustrated scenario, user 104 (who already may maintain existing channel 126) adds (130) new channel 132. This new channel 132 might normally be hidden away from viewer's eyes because it has not gathered enough community attention to be rated favorably by existing ranking methodologies. The proposed ranking determining component 128 offers an alternative means for users to explore content available on the site by providing an initial ranking 134, and thereby improves user experience. For channel contributors and owners, being showcased offers encouragement to continually upload better content and to remain loyal to the site. Having quality content hosted on the site, in turn, can entice new members to join and this in turn benefits the site operator.

Although the channel 132 may be shown and described as “newly added,” it will be appreciated that the “newness” may be a relative term that depends on a particular implementation. Generally, the initial ranking 134 is independent of any activity metrics currently associated with the channel 132, thus may be used for ranking the channel 132 in situations where little or no activity metrics exist, e.g., after the channel 132 has been added but before any activity is attributed to the channel. However, the assignment of the initial ranking 134 does not preclude the use of the initial ranking 134 in combination with other rankings (e.g., based on directly applicable activity metrics) when performing rank ordering or other functions as described herein.

The ranking component 128 may take into account a number of data parameters in order to determine an initial ranking 134 for a newly added channel 132. The channel settings may allow content contributions to a channel by others. This is indicated by paths 136-138, which show contributions between channels 114, 124, and 126. It will be appreciated that the contributions need not originate from other public channels as illustrated. Users 102-104 may contribute to channels of others using private channel content, or using content that is not stored elsewhere in repository 106. Although the contributions 136-138 may include various types of media, including text, it will be appreciated that the contributions 136-138 in this scenario refers to contributions of channel content, and to not contributions of peripheral data that describes the content (e.g., comments, metadata).

Another type of interaction between users is shown by path 140, which indicates a subscription by user account 109 to content from channel 126 of user 104. Such a subscription 140 may involve viewing (e.g., directly or via a link) content of channel 126 from home page of account 109. In other arrangements, the subscription 140 may involve receiving alerts (e.g., email, news-feed reader) of changes to the targeted channel 126.

As will be described in greater detail hereinbelow, these and other activities involving the creator 104 of the new channel 132 and other users 102, 103 can provide a probability indicator that the new channel 132 may contain interesting content. As a result, the initial ranking 134 can be formed to reflect this probability. As time goes on, activity/access factors (e.g., number views, links) will ensure the channel 132 obtains a higher or lower ranking based on actual use. Even though the channel 132 may obtain a high ranking over time without a high initial rank estimate 134, this initial estimate 134 can increase speed of obtaining that eventual ranking, and that the material can be viewed by more people while the content is still fresh and relevant.

As a hypothetical use case, consider Joe, who is a professional photographer, is also an avid contributor to a media sharing site. He owns a public channel devoted to cats where he publishes his best cat photos. His channel is well received by the community and has a high number of view counts. Joe also frequently contributes photos to other popular animal-themed public channels owned by other members. Joe has just returned from a safari trip in Serengeti and he wishes to share his wildlife photos with others through his newly created safari channel. Around the same time that Joe created and published his safari channel, hundreds of other members also submitted their new channels. Some of these channels are created by new members and some not. In any case, Joe's safari channel is rated favorably under the site's “Most Interesting New Channel” category because he has as good track record in contributing to popular channels. Because of the favorable rating given to his channel and exposure received from being in the top page, his safari channel reaches out to the viewers faster and the viewers benefited by the quicker path to quality content.

Data contained in a user profile may have effect on new channel's rating. For example, in the above example, it may be further assumed that Joe normally contributes photographs of animals. Thus his profile may automatically or manually list “animal photography” as an interest and/or specialty. Thus when Joe creates or contributes to a new channel containing media unrelated to animals (e.g., car pictures), Joe's contributions may not be weighted as high as it would if the new channel contained animal pictures. However, if another contributor, Jim, was identified as regularly contributing and/or specializing in car photos, then Jim's contributions may be more highly weighted in the eventual initial ranking of the new car photo channel.

As can be seen in the above example, the potential interestingness of a channel may be based on the prior performance of the channel's contributors in creating popular channels. As mentioned previously above, there are several metrics that could be used use for measuring the popularity of these other channel and they may be computed based on community activities relative to a channel. The popularity metrics of the other channels can be applied as an estimate of the popularity of the new channel.

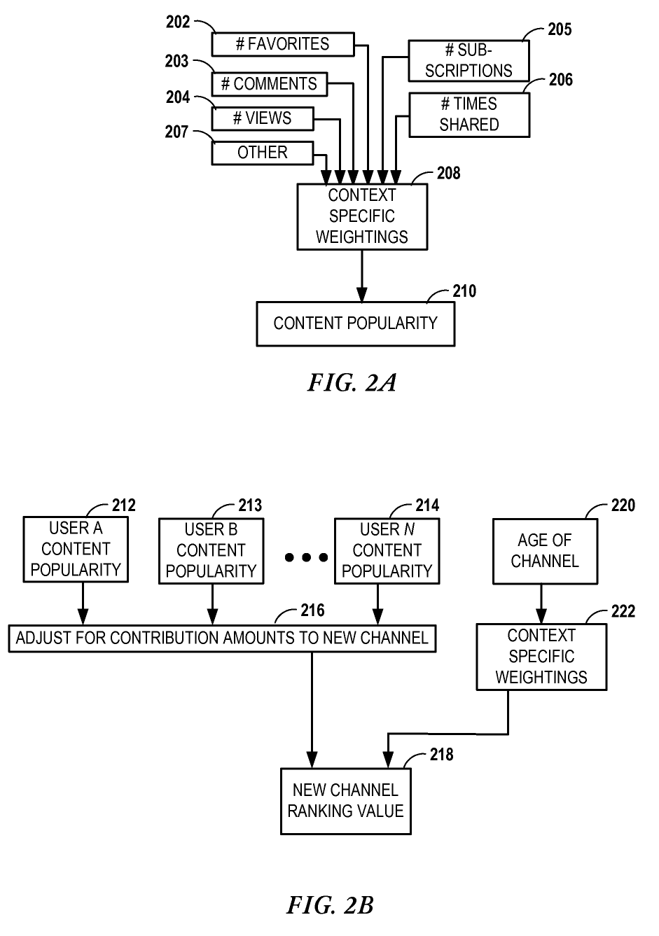

The popularity score of to other channels (e.g., on a scale of 0 to 1) may be computed based on activity counts. The determination of a popularity score for a channel (or some part thereof) in an example embodiment is shown as a block diagram in FIG. 2A. Specific activity related to a channel (or a subcomponent thereof) may be considered, such as number of times listed in somebody's favorites 202, number of comments 203, number of views 204, number of subscriptions/subscribers 205, and number of times shared 206. Other factors 207 may also be appropriate to a particular search or view, such as content type, subject matter, language/locale, keywords, content size, etc.

Each of the factors 202-207 may have a separate weighting applied, as indicated in block 208. The weightings may be tailored to a particular view, result set, search type, site operator, etc. For example, a pre-configured category such as “most viewed” may depend primarily or entirely on the number of views metric 204. After weightings are applied 208, the resulting popularity 210 is associated with the channel (or other content object). For purposes of further discussion, a symbolic representation of the factors shown and described in FIG. 2A are presented in Listing 1 below. The variables in Listing 1 use a subscript indicating association with a particular channel “Z” and are defined as ratios of the particular channel's metric versus the same metric as applied to all relevant channels.

Listing 1

Let v_{Z} = (# of views for channel Z)/(total # of views for all channels)
Let c_{Z} = (# of comments for channel Z)/(total # of comments for all
channels)
Let f_{Z} = (# of favorites for channel Z)/(total # of favorites for all channels)
Let s_{Z} = (# of times shared for channel Z)/(total # of times shared for all
channels)
Let m_{Z} = (# of subscriptions for channel Z)/(total # of subscriptions for all
channels)

Generally, a channel popularity metric associated with a particular user can be a predictor of the popularity of new channel where that same user is a contributor to the new channel. Because the example embodiments include channels may have more than one contributor, an initial popularity indicator for the new channel may be based on the relative popularity of contributors in proportion to contributions by those contributors. This is shown in the block diagram of FIG. 2B. Content popularities 212-214 for contributors are determined based on existing contributions (e.g., using popularity metric 210 shown in FIG. 2A). The individual metrics 212-214 are adjusted 216 based on the relative amount of content contributed to the new channel. This adjusted value is used to find the ultimate ranking metric 218 for the new channel.

Another factor that may affect this final value is the age of the channel 220, which may be weighted 222 based on particular context of the search. If the goal is to help raise the profile of newly added content, then the resulting effect on the final ranking 218 could be inversely proportional to the age 220 of the channel. The weighting 222 may result in this inverse effect, and may also provide other adjustments to reflect the importance of age 220 relative to other factors (e.g., contributor metrics 212-214). In this example, the age 220 may refer to the age of the channel measure from its initial formation, and/or may reflect ages (e.g., creation, modification) of constituent content of the channel.

In Listings 2-4 below, pseudo-code illustrates the computation of new channel ranking as outlined in FIG. 2B. Listing 2 shows the computation of each member's share of the popularity based on his/her amount of content contribution to the channels.

Listing 2

```
For each user X,
    Let i_{X} = interest metric of user X, initially set to 0
    For each channel Z,
        Let p = proportion of content in Z contributed by X
        // increment user X's interest metric based on his/her amount of
        // contribution to channel Z
        Let i_{X} = i_{X} + p * (wᵥ*v_{Z} + w_{c}*c_{Z} + w_{f}*f_{Z} + wₛ*s_{Z} + wₘ*m_{Z})
```

In one example embodiment, each of the constants wᵥ, w_{c}, w_{f}, wₛ, wₘ in listing 2 may be a non-negative real number in the range of 0 to 1, such that the sum of the constants equals one, i.e., wᵥ+w_{c}+w_{f}+wₛ+wₘ=1. These constants can weight the importance of a particular activity count. For example, one configuration could have wᵥ=1 and w_{c}=w_{f}=wₛ=wₘ=0. This configuration would thereby ignore all activity count except views. It can be left up to the site operator to choose the values most preferable for the site.

Finally, the interest metric (e.g., “interestingness”) for a new channel is computed based on the interest metric of its contributors, as seen below in Listing 3.

Listing 3

```
For each channel Z,
    Let i_{Z} = interestingness of channel Z, initially set to 0
    For each contributor X to channel Z,
      Let p = weighted proportion of content in Z contributed by X
      // compute channel interestingness based on interestingness of its
      contributors
    i_{Z} = i_{Z} + p_{Z} * i_{X}
```

The content proportion value “p_{Z}” in Listing 3 (as well as the proportion value “p” shown in Listing 2) may be weighted so that the channel interestingness is not overly sensitive to a single contributor. There are a number of ways to perform this weighting, such as taking the square root, cube root, and/or log of the contribution ratio.

As mentioned above, in order to promote newly created channels, it might be useful to attenuate a channel's interest metric by the channel's age. The actual attenuation function to use may be based on the preferences of the site operator. For example, given t_{Z} as the number of minutes elapsed since the creation of channel Z, some possible attenuation functions are shown in Listing 4 below.

Listing 4

| | |
|---|---|
| i_{Z}′ = i_{Z} − i_{Z} *β*t_{z}, where β is a real number with a range of 0..1 | (1) |
| i_{Z}′ = t_{Z}^{-α} * i_{Z}, where α is a real number ≧ 1 | (2) |

The eventual output from the algorithm is a list of interestingness scores (stored in i_{Z} or i_{Z}′) for channels with the most potentially interesting channel having the highest score. Using these scores then, the channels can be ranked by sorting i_{Z}′ in descending order, and/or ranked probabilistically if the scores are normalized so that they sum to one. In the probabilistic ranking case, the channels are selected for display from the search domain based on their probabilities of being relevant. In such a case, the probability of a channel being relevant may be based, wholly or in part, on the interestingness score. In one variation, the list of candidate channels can be “pruned” by using a minimum floor/ceiling threshold, and/or by selecting the top N-channels. Whatever results remain from this pruning may have their scores normalized so they sum to 1. In such a scheme, the score-based ordering of the channels is perturbed a bit, and may add some surprise to the recommendation. For example, with this scheme, each time the recommendation page is visited, a few different channels may be shown (assuming this is what the site operator wants).

The different ranked views described above can be presented (either alone or in combination) to the viewers as an alternative way of browsing the channels. Advantages of these example embodiments are that newly created channels which have not had time to gather enough community attention in the form of viewing, commenting, bookmarking, sharing and/or subscription can be more effectively explored by users. This in turn improving user experience and provides incentives to contribute better content as a result of the extra exposure.

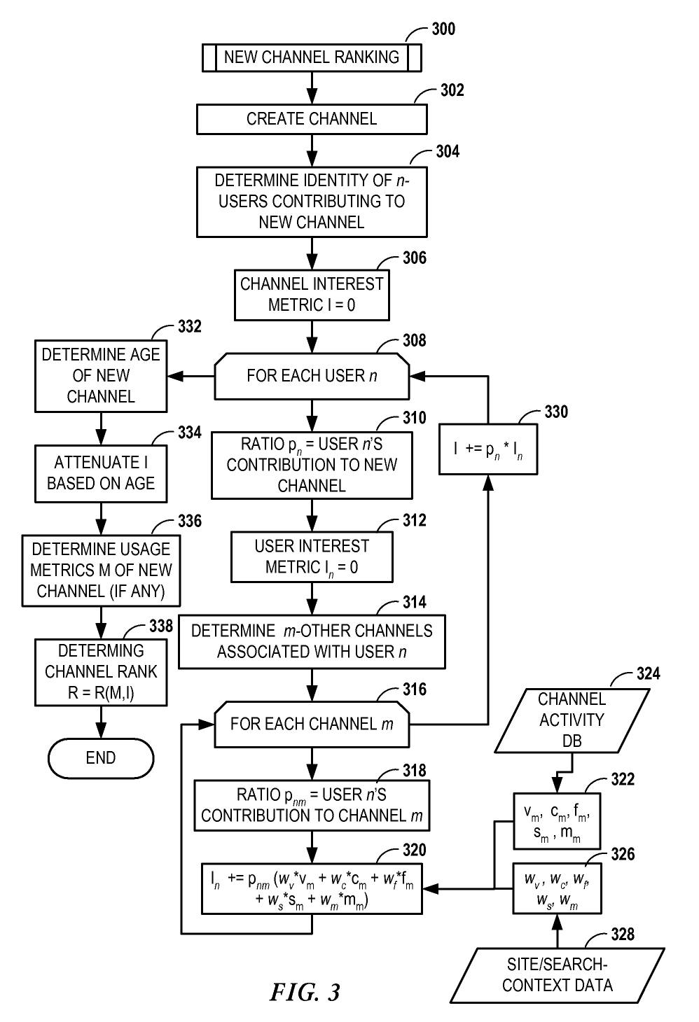

In FIG. 3, a flowchart illustrates an example embodiment of a procedure 300 for ranking a new channel. The procedure 300 is generally applicable to creation 302 of a new channel, although various steps following the creation 302 can be regularly performed after channel creation 302 to update the new channel's ranking. The procedure 300 involves determining 304 the identity of n-users who are contributing to the channel. Generally, it may be assumed that the users are all members of the same media sharing services, although it may be possible to adapt the system to account for activity of contributors outside of the media sharing channel. Thus, if a contributor (who may need to sign up for an account on the current media sharing site to contribute) has little activity on the affected site, but is very popular on video sharing site X, the illustrated procedure may be adapted to derive similar interest metrics from site X. This may require linking the identity of the user on the contributed site with the identity on site X, and this might be determined via user registration to the media sharing service.

The interest metric I is initialized 306 to zero, and a loop 308 iterates once for each of the n-users. In this loop, the ratio of each user's contribution is determined 310, and an interest metric Iₙ for the user n is initialized 312 to zero. The procedure then determines 314 m-channels associated with user n, and then over each of the m-channels in loop 316. As mentioned above, these m-channels may be channels of the same media sharing system in which the new channel is created. Some of the m-channels may also be from some other media sharing system where similar metrics can be derived, and the user's identity from that other system can be linked as a contributor to the new channel.

In the loop 316, the user's contribution to channel m is determined 318, and the interest metric Iₙ is incremented 320 using the formula shown in Listing 2 above. This calculation 320 may involve pulling the activity metrics 322 from an activity database 324 associated with the media sharing system(s). The calculation 320 may also involve obtaining weighting values 326 that are context-specific to a particular site or search, as represented by context data 328. It will be appreciated that the particular activity metrics 322 and weightings 326 are presented for example, and other metrics/weightings known in the art may be used. For example, if activity metrics from external sites are considered, then other metrics may be used instead of or in addition to the example metrics shown (e.g., recommendation rankings such as Digg™).

At the termination of the channel loop 316, the total interest metric I is incremented 330 by the contributions of user n, and the outer loop 308 continues. Note that the incrementing 330 may involve using a weighted value of pₙ that decreases sensitivity to extreme or outlier user rankings (e.g., as described above in relation to Listings 2-3). Upon exiting the outer loop 308, the metric I reflects relative interestingness of the n-users, and the age of the new channel is determined 332. The metric I is attenuated 334 based on this age. Finally, although the channel may be relatively new, it may still have had some activity metrics of its own that can be determined 336. The total ranking of the channel is then determined 338, and can be used for purposes such as user searches, pre-formed views (e.g., new channels of interest), etc. It can be seen that as I steadily decreases 334 due to aging of the channel, the usage metrics 336 will dominate the ranking. In such a case, the procedure 300 may test (not shown) for a minimum age to determine if I even needs to be calculated, and may therefore skip loop 308 in that case.

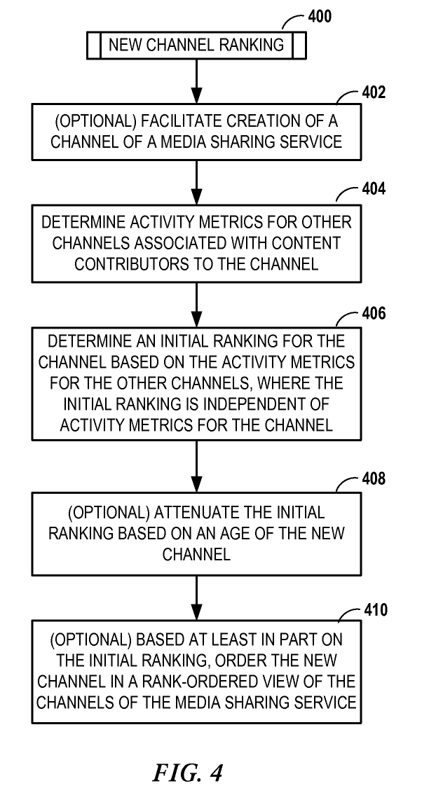

In FIG. 4, a flowchart shows a general procedure 400 for ranking new channels according to an example embodiment of the invention. Creation of a new channel of a media sharing service may optionally be facilitated 402, e.g., via a web interface. Channels of the media sharing service may include collections of network-accessible media objects. Each of the channels of the media service may be capable of accepting the respective media objects from a plurality of contributors.

Activity metrics for other channels associated with contributors to the new channel are determined 404, and an initial ranking for the new channel is determined 406 based on the activity metrics for the other channels. This initial ranking is independent from (e.g., does not rely upon) activity metrics associated with the channel, although may be combined with activity metrics in determining a composite ranking. This initial ranking may optionally be attenuated 408 based on an age of the new channel. Based at least in part on the initial ranking, the new channel may optionally be ordered 410 in a rank-ordered view of the channels of the media sharing service. The rank ordered view may be a predefined view of the web service, and/or may be in response to a search query.

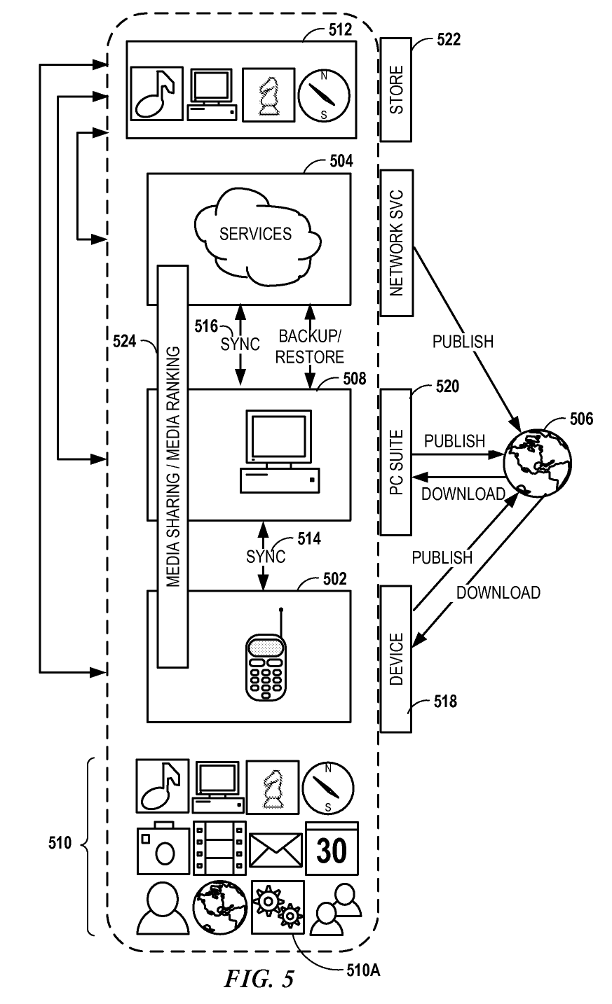

In reference now to FIG. 5, a block diagram illustrates an example system in which embodiments of the invention may be employed. It will be appreciated that users will be increasingly relying on mobile devices 502 for content creation and viewing. At the same time, such users will also increasingly utilize network services 504 (e.g., media sharing services as described herein) and the Internet 506 to extend the capabilities of the mobile devices 502. Many users will continue rely on traditional personal computers (PC) 508 for these and other purposes. In some scenarios, the personal computing layer 508 may become nearly transparent, e.g., presenting a lightweight interface between the networks 504, 506 and the mobile devices 502. In other scenarios, the mobile device 502 and services 504 may interact directly, without the need for PC applications 508 acting as middleware.

In order to present a friendly and flowing user experience, the illustrated system need not be structured by technologies or tasks. In this example, the system is built around suites, stations, categories, and players. Using such a paradigm, people can easily understand know where to go and what to do. Where the user's content 510 actually “lives” is irrelevant, since nearly everything is accessible from all three platforms. From an information standpoint, the illustrated architecture encompasses three platforms (Device 502, PC 508, and Web 506) and a centralized store 512. The content 510 is cross-platforms and may be organized around particular suites such as games, music, photos, maps, video & television, the Internet, contacts, calendar, messages, and settings. The settings suite (represented by icon 510A) allows access to a control panel that enables seamless configuration of behavior over the entire architecture.

As indicated by paths 514 and 516, the mobile device 502 and services 504 are synchronized. As the capacity of the device 502 may differ from that of the PC 508, the syncing 514, 516 may be mediated by a system of subsets and playlists. The PC 508 may include a software suite that provides the PC 508 with a desktop interface to the service 504. The PC 50 and device 502 may also include respective interfaces 518, 520 that enable people to create “snapshots” of their content, and save it onto an account with the service 504. Further, the store 512 includes an Internet interface 522, and devices 502, 508 may always have access to the store 512, either directly or via services 504.

As described herein, the services 504 may include media sharing capability 524 via public channels that accept content from multiple contributors. This media sharing feature 524 may also include ranking functions that are used to determine content/channel presentation and respond to searches (e.g., as shown and described relative to FIGS. 1, 2A, 2B, 3, and 4). The ranking and search functions 524 may work across all of the layers 502, 504, and 508, and maybe applicable to some or all of the application suites 510 distributed across the architecture. For example, contributors to media sharing channels (e.g., channels 114, 124, 126 in FIG. 1) may also be involved in contributing other types of content to these or other channels. The interest metric of such a contributor may determined by other public content contributions, such as games (e.g., measured by skill in creating and/or playing), ratings/comments, navigation/mapping contributions (e.g., geo-caches, collections of points of interest), etc. Such interest metric data related to particular contributors may be spread across different layers 502, 504, and 508, and may utilize data across those layers 502, 504, 508 to better gauge the interestingness of a particular user or group of users.

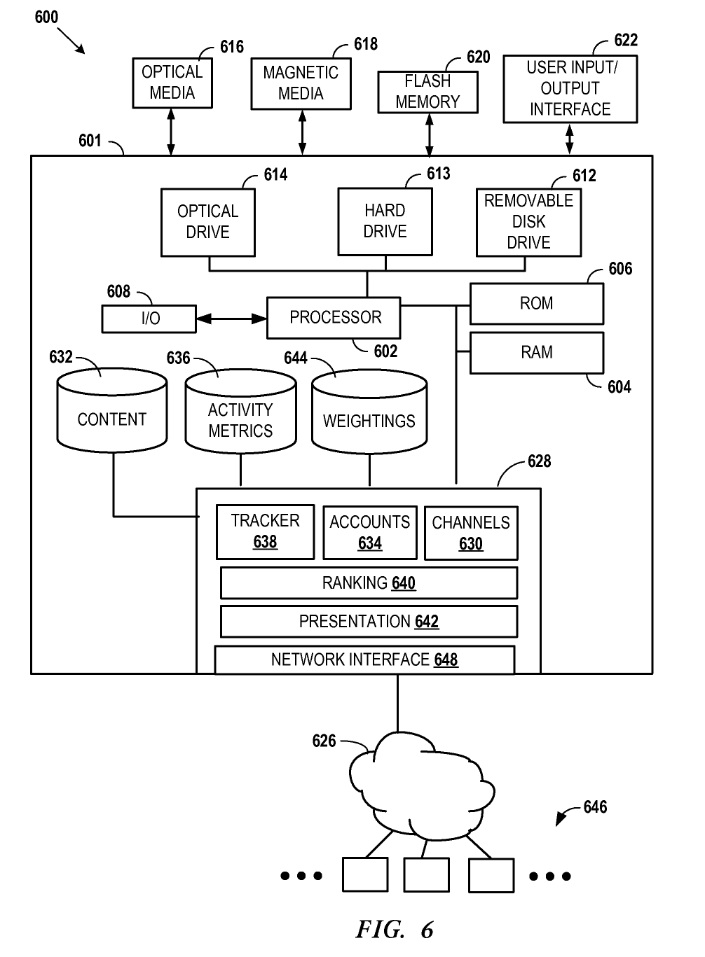

In reference now to FIG. 6, a block diagram provides details of a network service 600 that provides interest metric rankings for newly created content according to embodiments of the invention. The service 600 may be implemented via one or more conventional computing arrangements 601. The computing arrangement 601 may include custom or general-purpose electronic components. The computing arrangement 601 include one or more central processors (CPU) 602 that may be coupled to random access memory (RAM) 604 and/or read-only memory (ROM) 606. The ROM 606 may include various types of storage media, such as programmable ROM (PROM), erasable PROM (EPROM), etc. The processor 602 may communicate with other internal and external components through input/output (I/O) circuitry 608. The processor 602 may include one or more processing cores, and may include a combination of general-purpose and special-purpose processors that reside in independent functional modules (e.g., chipsets). The processor 602 carries out a variety of functions as is known in the art, as dictated by fixed logic, software instructions, and/or firmware instructions.

The computing arrangement 601 may include one or more data storage devices, including removable disk drives 612, hard drives 613, optical drives 614, and other hardware capable of reading and/or storing information. In one embodiment, software for carrying out the operations in accordance with the present invention may be stored and distributed on optical media 616, magnetic media 618, flash memory 620, or other form of media capable of portably storing information. These storage media may be inserted into, and read by, devices such as the optical drive 614, the removable disk drive 612, I/O ports 608 etc. The software may also be transmitted to computing arrangement 601 via data signals, such as being downloaded electronically via a network 626, such as the Internet. The computing arrangement 601 may be coupled to a user input/output interface 622 for user interaction. The user input/output interface 622 may include apparatus such as a mouse, keyboard, microphone, touch pad, touch screen, voice-recognition system, monitor, LED display, LCD display, etc.

The service 600 is configured with software that may be stored on any combination of memory 604 and persistent storage (e.g., hard drive 613). Such software may be contained in fixed logic or read-only memory 606, or placed in read-write memory 604 via portable computer-readable storage media and computer program products, including media such as read-only-memory magnetic disks, optical media, flash memory devices, fixed logic, read-only memory, etc. The software may also placed in memory 606 by way of data transmission links coupled to input-output busses 608. Such data transmission links may include wired/wireless network interfaces, Universal Serial Bus (USB) interfaces, etc.

The software generally includes instructions 628 that cause the processor 602 to operate with other computer hardware to provide the service functions described herein. The instructions 628 includes a channels service 630 that arranges and presents user-contributed content 632 as collections that are defined by at least one user. Such users will generally establish accounts via an account service 634, and the account service 634 may be centralized for an entire cross-platform user service as described herein (e.g., architecture shown in FIG. 5). Each channel 630 may be owned/supervised by one user account, although multiple users may contribute to the channel.

The service 600 may gather activity metrics 636 relative to the channels 630, as represented by tracker component 638. These metrics may include factors shown in Listing 1, and other data that may be indicative of the quality of an individual's contributions (e.g., peer rankings, exposure on the Internet or social networking sites, commercial success of other content created by the user). A ranking engine 640 can take into account these metrics 636 and other data available via channel service 630, accounts service 634, and activity tracker 638 to obtain context-free ranking data. For example, user profiles may be available from the accounts service 634 that determine whether a particular user's contributions may be weighted by the ranking engine higher or lower than other contributors. Such user profile considerations may be such parameters as past subject matter contribution trends, flags by others of consistently relevant/irrelevant contributions by the user, geographical/language settings, etc.

A presentation layer 642 may obtain ranking from the ranking engine 640 and apply weighting data 644 that varies based on the context of the presentation. For example, the same ranking data can have different weights applied to present different data ordering for categories such as most popular new content, most commented new content, etc. The presentation layer 642 can be easily adapted to produce a variety of results by selective combination of weighting 644 with outputs of the ranking engine 640. The tracker 638, ranking engine 640, and presentation layer 642 may include other features that are shown and described hereinabove relative to FIGS. 1, 2A, 2B, 3, and 4.

The computing arrangement 601 may be coupled to other computing devices 646 via networks 626. The computing arrangement 601 includes a network interface 648 for interacting with clients 628 for purposes such as receiving content 632, providing channel service 630, performing searches, viewing ranked channels via presentation layer 642, etc. The network interface 648 may include a combination of hardware and software components, including media access circuitry, drivers, programs, and protocol modules. The network interface 648 may include application level protocols such as Hypertext Transport Protocol (HTTP) for delivery of content from the presentation layer 642. Such content may be delivered in formats such as Hypertext Markup Language (HTML), eXtensible Markup Language (XML), plain text, graphics, etc. For example, a rank-ordered view of the channels may be presented via the presentation layer 642 in response to a query and/or in a predefined view of the service 600 (e.g., most popular, most commented). These protocols and formats can also be used for receiving content from user device 646, such as via HTML forms for posting content to the channel service 630, and for gather activity metrics 636 via the tracker 638.

For purposes of illustration, the operation of the service 600 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 601 is only a representative example of network infrastructure hardware that can be used to provide location-based services as described herein. Generally, the functions of the computing service 600 can be distributed over a large number of processing and network elements, and can be integrated with other services, such as Web services, gateways, mobile communications messaging, etc. For example, some aspects of the service 600 may be implemented in user devices 646 (and/or intermediaries such as PC 508 shown in FIG. 5) via client-server interactions, peer-to-peer interactions, distributed computing, etc.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1 A method, comprising:
determining content contributors to a channel;
determining activity metrics for other channels associated with the content contributors; and
providing an initial ranking for the channel based on the activity metrics for the other channels, wherein the initial ranking is independent of activity metrics associated with the channel.

2. The method of claim 1, wherein the channel comprises a collection of network-accessible media objects of a media sharing service, and wherein the channel comprises media objects from the content contributors.

3. The method of claim 1, wherein the initial ranking is provided for purposes of ordering the channel, based at least in part on the initial ranking, in a rank-ordered view of channels of a media sharing service.

4. The method of claim 1, further comprising attenuating the initial ranking based on an age of the new channel.

5. The method of claim 1, wherein the channel is supervised by a single one of the contributors to the new channel.

6. The method of claim 1, wherein the initial ranking of the channel is provided in response to a search query.

7. The method of claim 6, further comprising applying weightings to each of the activity metrics, wherein the weightings are selected based on parameters of the search query.

8. The method of claim 1, wherein the initial ranking of the channel is provided in response to requesting a predetermined view of a media sharing service.

9. The method of claim 8, further comprising applying weightings to each of the activity metrics, wherein the weightings are selected based on parameters defined for the predetermined view of the media sharing service.

10. An apparatus comprising:
one or more processors configured to:
determine content contributors to a channel;
determine activity metrics for other channels associated with the content contributors; and
provide an initial ranking for the channel based on the activity metrics for the other channels, wherein the initial ranking is independent of activity metrics associated with the channel.

11. The apparatus of claim 10, wherein the channel comprises a collection of network-accessible media objects of a media sharing service, and wherein the channel comprises media objects from the content contributors.

12. The apparatus of claim 10, wherein the initial ranking is provided for purposes of ordering the channel, based at least in part on the initial ranking, in a rank-ordered view of channels of a media sharing service.

13. The apparatus of claim 10, wherein the initial ranking of the channel is provided in response to a search query.

14. The apparatus of claim 13, wherein the processors are further configured to apply weightings to each of the activity metrics, wherein the weightings are selected based on parameters of the search query.

15. The apparatus of claim 10, wherein the initial ranking of the channel is provided in response to requesting a predetermined view of a media sharing service.

16. The apparatus of claim 15, wherein the processors are further configured to apply weightings to each of the activity metrics, wherein the weightings are selected based on parameters defined for the predetermined view of the media sharing service.

17. A computer-readable storage medium comprising:
instructions which are executable by an apparatus for performing operations that include:
determining content contributors to a channel;
determining activity metrics for other channels associated with the content contributors; and
providing an initial ranking for the channel based on the activity metrics for the other channels, wherein the initial ranking is independent of activity metrics associated with the channel.

18. The computer-readable storage medium of claim 17, wherein the channel comprises a collection of network-accessible media objects of a media sharing service, and wherein the channel comprises media objects from the content contributors.

19. The computer-readable storage medium of claim 17, wherein the initial ranking is provided for purposes of ordering the channel, based at least in part on the initial ranking, in a rank-ordered view of channels of a media sharing service.

20. The computer-readable storage medium of claim 17, further comprising applying weightings to each of the activity metrics, wherein the weightings are selected based on any combination of a) first parameters defined for a predetermined view of a media sharing service; and b) second parameters of a search query.

21. An apparatus comprising:
means for determining content contributors to a channel;
means for determining activity metrics for other channels associated with the content contributors; and
means for providing an initial ranking for the channel based on the activity metrics for the other channels, wherein the initial ranking is independent of activity metrics associated with the channel.

22. The apparatus of claim 21, further comprising means for applying weightings to each of the activity metrics, and further comprising one or more of:
means for selecting the weightings based on parameters defined for a predetermined view of a media sharing service; and
means for selecting the weightings based on parameters of a search query.
